(19) United States
(12) Patent Application Publication
(10) Pub. No.: US 2007/0296200 A1
(43) Pub. Date: Dec. 27, 2007

(54) Children's drawing pad

(76) Inventor: Trey Glendon Taylor, McKinney, TX (US)

Correspondence Address: JACKSON WALKER LLP, 901 MAIN STREET, SUITE 6000, DALLAS, TX, 75202-3797, US

(21) Appl. No.: 11/451,278

(22) Filed: Jun. 12, 2006

(51) Int. Cl. B42D 1/00

(52) U.S. Cl. 281/38

(57) ABSTRACT

A drawing pad for use by children having a drawing surface, a middle foam layer, and a non-slip surface. Users can write on the drawing surface with a material such as chalk and easily erase the writing. The foam layer is a soft material that is also semi-rigid to keep the drawing pad from wrinkling. The non-slip surface keeps the drawing pad from slipping and is also non-porous and easily cleaned. The drawing pad is suitably large and can be easily rolled up and transported.

### FIELD OF THE INVENTION

The present invention is generally related to a drawing pad for children and more particularly to a soft, foldable, portable pad with non-slip backing and an erasable surface that can be drawn upon with chalk.

### BACKGROUND OF THE INVENTION

Drawing has always been a popular activity with children. Besides being an activity that is enjoyable for the child, it is also very valuable in developing creativity and other important behaviors. Drawing improves reading, writing, and motor skills. Children who draw in groups can also enhance their abilities to cooperate, share, and express themselves verbally.

Erasable surfaces are ideal drawing surfaces for children. While items such as coloring books and paper pads are also suitable for drawing, these items are not reusable and can be expensive to replace repeatedly. Chalk boards and dry erase boards can be drawn upon, erased, and reused multiple times. Chalk boards are clearly the most preferred erasable drawing surface for children. Dry erase markers are not ideal for young children due to their potential to stain clothing and their tendency to have strong, undesirable smells.

The disadvantage of chalk boards is that they are not easily transported, particularly if they are of a large size. They are solid boards that cannot be refolded. While chalk boards that are smaller in size may be carried with little trouble, they do not allow very much space to draw.

Children also enjoy coloring and drawing with chalk and playing games on sidewalks and driveways. Although these surfaces provide a large drawing space, they also suffer from the drawbacks of being non-erasable and non-portable. In addition, the rough surface of a sidewalk or driveway can be hard on children's hands, knees, and other parts.

There is desired an improved drawing pad for children that is of a large size, erasable, and easily transportable.

### SUMMARY OF INVENTION

The present invention achieves technical advantages as a drawing pad for children that has additional uses. The drawing pad is comprised of three layers, including an erasable top surface and a non-slip back surface, and is soft, portable, and a large size.

In addition to serving as an easily transportable, erasable drawing surface, the drawing pad has other advantageous features. It can serve as a soft, semi-rigid play surface for children and their toys. This is often preferable to allowing children to sit directly on the floor, particularly in unfamiliar locations or on hard or rough surfaces. The drawing pad can also serve as a “drop cloth” for messy activities by turning it over so that the non-slip back surface is exposed. The non-slip surface is a non-porous, easy-to-clean surface.

The entire drawing pad is semi-rigid to provide a stable surface, but it is flexible enough to be easily rolled up for transport.

### BRIEF DESCRIPTION OF THE DRAWINGS

FIG. 1 is top view of the drawing pad; and

FIG. 2 is a cross-sectional view of the drawing pad.

### DETAILED DESCRIPTION OF THE PRESENT INVENTION

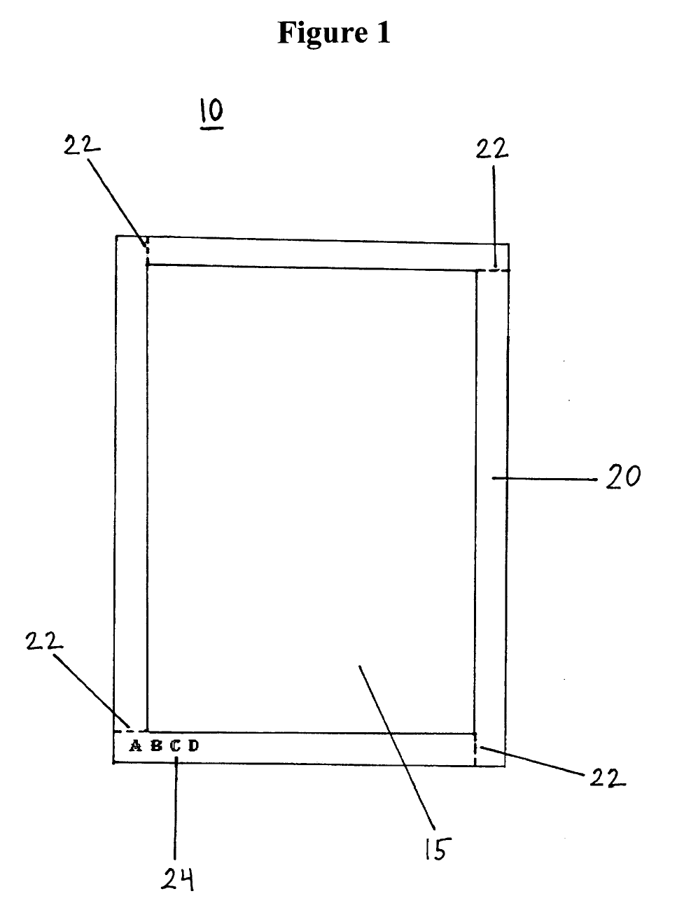

Referring now to FIG. 1, there is shown generally at 10 a drawing pad. In a preferred embodiment, the drawing pad 10 can have a border 20 sewn around the exterior edges. Stitches 22 may be used to secure the border 20 around the edges of the drawing pad 10. The border 20 can be made of any suitable material, including nylon. The area inside the border 20 is the drawing area 15.

The border 20 is useful for different purposes. First, it can provide its own printable surface. It also prevents the pad edges from being exposed and potentially fraying. The border 20 can also be printed with various decorative symbols 24, such as numbers or letters, or any other indicia that make the pad attractive in appearance. Because the pad is intended primarily for use by children, educational symbols, such as numbers or letters, or drawings of cartoon characters are ideal decorative symbols 24.

The drawing pad 10 is preferably of a size large enough for children to sit comfortably on it and interact with the drawing surface and other toys. The drawing pad is preferably at least four feet long on each side. In one embodiment, the drawing pad 10 is five feet long and four feet wide. In another embodiment, the border 20 is two inches in width. These lengths can vary considerably based on any preferred dimensions and the size of the decorative symbols 24 to be applied to the border 20. In other embodiments, the drawing pad 10 can be small enough to be utilized in an automobile or an airplane.

In certain embodiments, the drawing area 15 can be imprinted with any desirable decorative material. The imprinted material is preferably non-erasable and permanent, so that children may regularly incorporate the material into their own drawings and activities. Examples of the decorative material that can be imprinted include gameboards and hopscotch patterns.

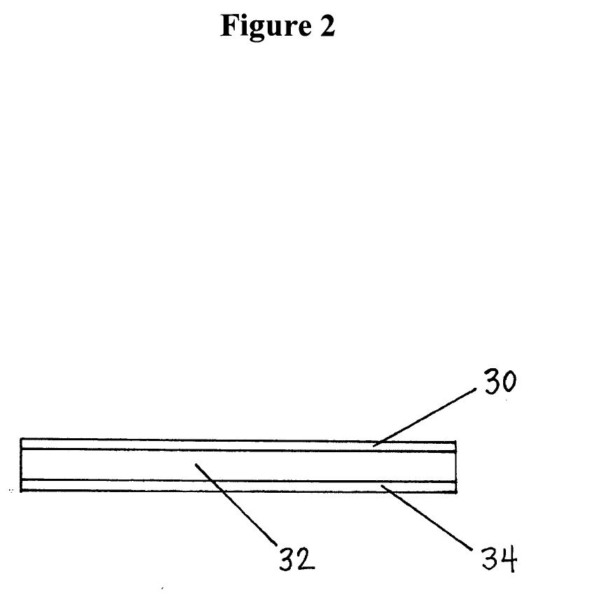

Referring to FIG. 2, a cross section of the drawing pad reveals three layers. At a top surface is a drawing surface 30. At a middle layer is a foam layer 32. At a bottom surface is a non-slip surface 34. The drawing surface 30 can be a woven fabric surface that provides a soft, pliable writing and erasing surface for chalk. Any suitable material can be used for the drawing surface 30, including fabrics such as polyester. The foam layer 32 can be an open-cell foam material. The foam layer 32 serves two useful functions. First, it provides a soft, cushioned surface on which children can sit and recline while playing. Second, it provides an amount of semi-rigidity to the drawing pad so that it will not wrinkle like a sheet or blanket.

The non-slip surface 34 can be any suitable non-slip material that is non-porous and easy to clean. In one embodiment, the non-slip surface 34 is a PVC material. The non-slip surface 34 serves three purposes. First, it prevents the drawing pad from slipping when someone stands or sits on it. Second, it provides a degree of semi-rigidity to the drawing pad so that it will not wrinkle. Finally, the non-slip surface 34 acts as a non-porous, easy to clean surface. Because the non-slip surface 34 is non-porous and easy to clean, the drawing pad can be flipped upside down to serve as a “drop cloth” for messy activities.

The three layers of the drawing pad, namely the drawing surface 30, the foam layer 32, and the non-slip surface 34, can be heat-laminated together to form a single three-ply drawing pad. All of the materials can be machine washable. The drawing pad is rigid enough to remain flat while children play but is flexible enough to be rolled up and moved.

In another embodiment, the drawing pad can be part of a kit including drawing materials, such as chalk, and an eraser.

Though the invention has been described with respect to specific preferred embodiments, many variations and modifications will become apparent to those skilled in the art upon reading the present application. It is therefore the intention that the appended claims be interpreted as broadly as possible in view of the prior art to include all such variations and modifications.

What is claimed is:

1. A drawing pad having exterior edges comprising:
a drawing surface;
a foam layer disposed beneath the drawing surface; and
a non-slip surface disposed beneath the foam layer,
wherein the drawing surface is a writable and erasable surface.

2. The drawing pad of claim 1, further comprising a border sewn around the exterior edges.

3. The drawing pad of claim 2, wherein decorative symbols are affixed to the border.

4. The drawing pad of claim 2, wherein the border comprises nylon.

5. The drawing pad of claim 1, wherein the drawing surface is fabric.

6. The drawing pad of claim 1, wherein the drawing surface is polyester.

7. The drawing pad of claim 1, wherein the drawing surface is imprinted with decorative material.

8. The drawing pad of claim 1, wherein the foam layer is an open-cell foam material.

9. The drawing pad of claim 1, wherein the non-slip surface is a PVC material.

10. The drawing pad of claim 1, wherein the drawing surface is a writable and erasable surface for chalk.

11. The drawing pad of claim 1, wherein the drawing surface, the foam layer, and the non-slip surface are heat-laminated together.

12. The drawing pad of claim 1, wherein the drawing pad is rectangular in shape and is at least four feet long on each exterior edge.

13. The drawing pad of claim 1, wherein the drawing pad is semi-rigid and capable of being rolled up.

14. A drawing pad kit comprising:
the drawing pad of claim 1;
one or more pieces of chalk; and
an eraser.
